(19) United States
(12) Patent Application Publication
(10) Pub. No.: US 2007/0216758 A1
(43) Pub. Date: Sep. 20, 2007

(54) Driving control device, image forming apparatus and recording medium for recording driving control program

(75) Inventor: Sadahiro Matsuura, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/374,920

(22) Filed: Mar. 14, 2006

(51) Int. Cl. B41J 27/00

(52) U.S. Cl. 347/261

(57) ABSTRACT

A control unit for a copying machine is equipped with a first rotation speed detecting unit for detecting a first rotation speed as a rotation speed of a polygon mirror; a switching judging unit for judging whether the first rotation speed reaches a value equal to or higher than a first switching speed set in advance; and a driving control unit for causing a second motor to start driving of a photoconductive drum, while causing a first motor unit to stop driving of polygon mirror for a mirror stop period set in advance, in the case that the switching judging unit judges that the first rotation speed reaches a value equal to or higher than the first switching speed, and, after the mirror stop period is over, causes the first motor to restart driving of the polygon mirror.

### BACKGROUND OF THE INVENTION

1. Field of the Invention

The present invention relates to a driving control device for use in an image forming apparatus which has a first driving unit for driving a polygon mirror adapted to scan a laser beam to be irradiated on a photoconductive drum so as to rotate the polygon mirror at a predetermined first reference rotation speed, and a second driving unit for driving the photoconductive drum so as to rotate at a predetermined second reference rotation speed, an image forming apparatus and a recording medium for storing a driving control program.

2. Description of the Related Art

Conventionally, in an image forming apparatus having a scanner motor for driving a polygon mirror adapted to scan a laser beam to be irradiated on a photosensitive drum, and a main motor for driving the photosensitive drum, a start-up procedure in image forming operation (for instance, printing) is carried out in accordance with the following procedure.

First, start driving of the scanner motor.

After the scanner motor has started up, start driving of the main motor.

According to an image forming apparatus having the above configuration (hereinafter referred to as “a conventional image forming apparatus”), because the period from an instruction to form an image until finishing a start-up procedure is the sum between the scanner motor start-up period and the main motor start-up period, a problem existed that the timing of the first printing is delayed (Refer to FIG. 7). Hereinafter, a description is given with reference to FIG. 7 in parallel with the embodiments of the present invention.

In order to solve the above problem, Japanese Unexamined Patent Publication No. Hei.7-334039 discloses an image forming apparatus whereby first, the scanner motor for driving the polygon mirror is activated and the main motor for driving the photoconductive drum is started up at a predetermined timing after the scanner motor is activated (the timing at which start-up of the main motor is completed, before the timing at which start-up of the scanner motor is completed).

However, because the main motor is started while the scanner motor is already active, in the configuration described above, a large power is required, which causes an increase in power capacity.

### SUMMARY OF THE INVENTION

In view of the foregoing, it is an object of the present invention to provide a driving control device, an image forming apparatus and a recoding medium for storing a driving control program capable of speeding up the timing for the first print while suppressing power requirements.

One aspect of the present invention is directed to a driving control device for use in an image forming apparatus having a first driving unit for driving a polygon mirror adapted to scan a laser beam to be irradiated on a photoconductive drum so that the polygon mirror is rotated at a first reference rotation speed set in advance and a second driving unit for driving the photoconductive drum so that the photoconductive drum is rotated at a second reference rotation speed set in advance, comprising: a first rotation speed detecting unit for detecting a first rotation speed as a rotation speed of the polygon mirror; a switching judging unit for judging whether the first rotation speed reaches a value equal to or higher than a first switching speed set in advance, after the first driving unit starts driving of the polygon mirror; and a driving control unit for causing the second driving unit to start driving of the photoconductive drum, while causing the first driving unit to stop driving of the polygon mirror for a mirror stop period set in advance, in the case that the switching judging unit judges that the first rotation speed reaches a value equal to or higher than the first switching speed, and, after the mirror stop period is over, causes the first driving unit to restart driving of the polygon mirror.

In this driving control device, if it is judged that first rotation speed as the rotation speed of the polygon mirror reaches a value equal to or higher than the first switching speed set in advance, since the second driving unit starts driving of the photoconductive drum, while the first driving unit stops driving of the polygon mirror for a mirror stop period set in advance, and after the mirror stop period is over, the first driving unit restarts driving of the polygon mirror, it is possible speed up the timing for the first print while suppressing power requirements.

These and other objects, features, and advantages of the present invention will become more apparent upon reading the following detailed description along with the accompanying drawings.

### BRIEF DESCRIPTION OF THE DRAWINGS

FIG. 1 is a side view of a copying machine as one example of the image forming apparatus according to one embodiment of the present invention.

FIG. 2 is a view showing a more detailed configuration of an exposure device of the copying machine shown in FIG. 1.

FIG. 3 is a block view showing an example of a functional configuration of a control unit of the copying machine shown in FIG. 1.

FIG. 4 is a flow chart showing an exemplary operation of the control unit shown in FIG. 3.

FIG. 5 is a timing chart showing an exemplary operation of the control unit shown in FIG. 3.

FIG. 6 is a timing chart showing an example of the changes occurring in a first rotation speed, a first synchronizing signal and a driving current value of a first motor during a first synchronizing period.

FIG. 7 is a timing chart showing an example of the operation of a conventional image forming apparatus.

### DETAILED DESCRIPTION OF THE PREFERRED EMBODIMENTS

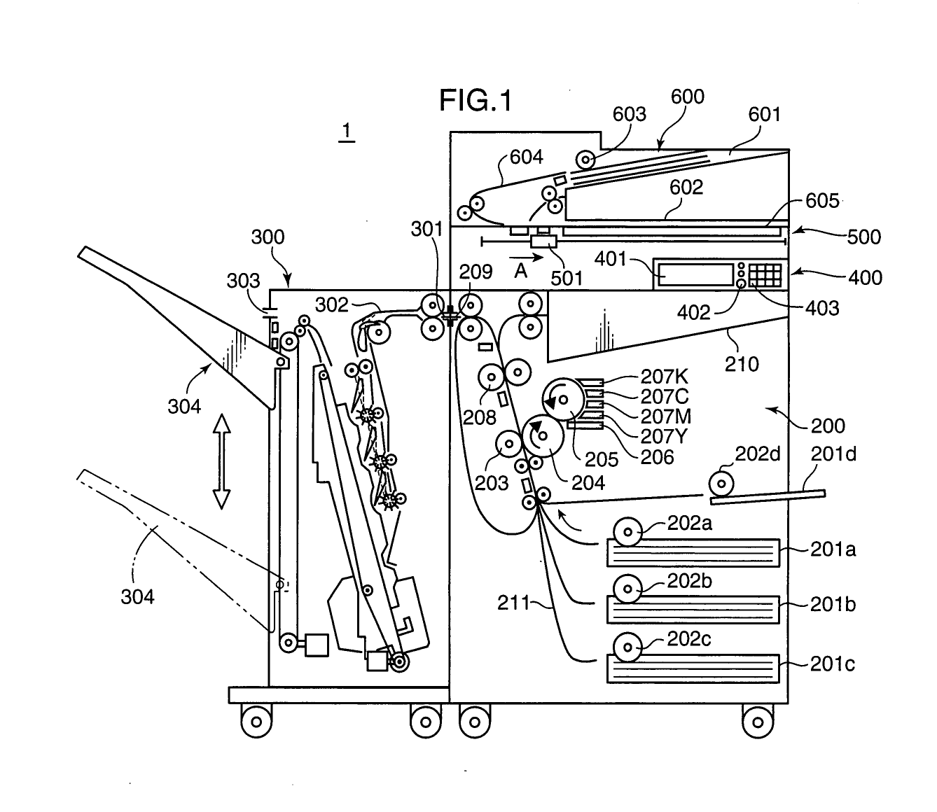

The invention is now described, by way of example, with reference to the accompanying drawings. FIG. 1 is a side view of a copying machine as an example of an image forming apparatus according to one embodiment of the invention. A copying machine 1 comprises: a main body 200, a sheet post-processing unit 300 disposed at a left side of the main body 200, an operating unit 400 for allowing a user to input a variety of operating instructions, a document reading unit 500 disposed on an upper side of the main body 200, and a document feeding unit 600 disposed above the document reading unit 500.

The operating unit 400 includes an operation panel 401, a start key 402, a keypad 403, and the like. The operation panel 401 displays a variety of operation screens and is formed of a Liquid Crystal Display (LCD) 401a and a touch panel 401b integrated with the LCD 401a, the LCD being adapted to display various operation buttons, etc. for allowing a user to input various operation instructions. The start key 402 is used by a user to input print execution instructions, or the like, while the keypad 403 is used to input the number of sets to be printed, or the like.

The touch panel 401b is comprised of a rectangular thin layer which has pressure-sensitive elements made of transparent material arrayed linearly thereon at a predetermine pitch in horizontal and vertical directions respectively, and a transparent cover which covers the elements. This touch panel 401b is attached onto the screen of the LCD 401a. The touch panel 401b is so configured as to enable to determine which button is designated, from the address of the button promoting a selection, etc. displayed on the screen of the LCD 401a and the pressure position.

The document feeding unit 600 comprises a document depositing unit 601, document discharge unit 602, a sheet-feed roller 603, a document conveyor path 604 and a contact glass 605, etc. The document reading unit 500 is equipped with a scanner 501.

The sheet-feed roller 603 grabs the document deposited on the document depositing unit 601, and the document conveyor unit 604 conveys in turn each page of the document grabbed by the sheet-feed roller 603. The scanner 501 has an image pickup device (CCD: Charge Coupled Device) and is adapted to read each page of the conveyed document sequentially. The read document is then discharged onto the document discharge unit 602. The scanner 501 reads the document placed on the contact glass 605 while the document is being moved along the contact glass 605 in a direction shown by arrow A (right direction in the drawing).

The main body 200 comprises a plurality (here, three) of sheet-feed cassettes 201a˜201c, a plurality (here, three) of sheet-feed rollers 202a˜202c, a manual sheet feeder 201d, a manual sheet-feed roller 202d, a transfer roller 203, an intermediate transfer roller 204, a photoconductive drum 205, an exposure device 206, developing devices 207Y, 207M, 207C and 207K for respectively developing the colors yellow (Y), magenta (M), cyan (C) and black (K), a fixing roller 208, an outlet 209, a discharge tray 210, a recording sheet conveyor path 211, and the like.

The photoconductive drum 205 is uniformly charged by a charging device (not shown), while being rotated in the direction of the arrow. The exposure device 206 converts the modulation signal which is generated based on the image data of the document read by the document reading unit 500, into a laser beam which is then outputted to thereby create on the photoconductive drum 205 an electrostatic latent image for each color. The developing devices 207Y, 207M, 07C and 207K supply to the photoconductive drum 205 a developer for each color to thereby forma toner image for each developing color. The toner image for each developing color is transferred from the photoconductive drum 205 to the intermediate transfer roller 204 whereby a color toner image is formed thereon.

On the one hand, the sheet-feed rollers 202a˜202c draw a recording sheet out of the sheet-feed cassettes 20la˜201c which store recording sheets, and the recording sheet conveyor path 211 conveys the recording sheet which was drawn out to the transfer roller 203. The transfer roller 203 transfers the toner image formed on the intermediate transfer roller 204 to the recording sheet which has been conveyed. The recording sheet having the toner image which has been transferred thereto is conveyed to the fixing roller 208 by the recording sheet conveyor path 211. The fixing roller 208 heats the transferred toner image to fix it to the recording sheet. The recording sheet having the toner image fixed thereto is conveyed to the outlet 209 via the recording sheet conveyor path 211 and fed to the sheet post-processing unit 300. The recording sheet may also be discharged onto the discharge tray 210, if needed.

The sheet post-processing unit 300 comprises an inlet 301, a recording sheet conveyor path 302, an outlet 303 and a stack tray 304, and the like. The recording sheet conveyor path 302 sequentially conveys the recording sheets fed from the outlet 209 to the inlet 301, and finally discharges the recording sheets from the outlet 303 onto the stack tray 304. The stack tray 304 is so configured as to be vertically movable in the direction of the arrow, according to the volume of stacked recording sheets carried out of the outlet 303.

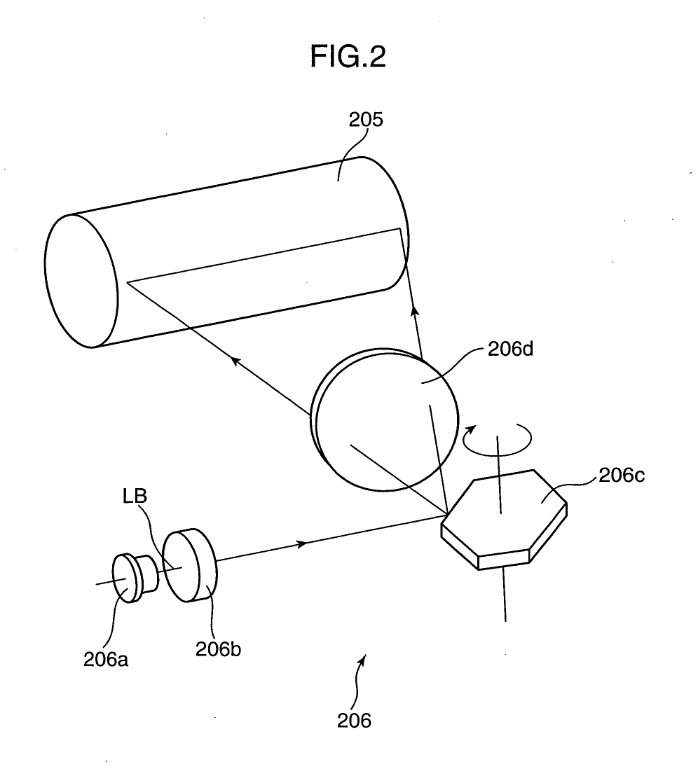

FIG. 2 is a view showing a more detailed configuration of the exposure device 206. The exposure device 206 comprises a laser diode 206a, a collimator lens 206b, a polygon mirror 206c, and an fθlens 206d. The laser diode 206a emits a laser beam LB. The collimator lens 206b gathers the laser beams LB emitted from the laser diode 206a into a beam of parallel rays.

The polygon mirror 206c scans the laser beams LB that passed the collimator lens 206b in a main scanning direction of the photoconductive drum 205. The fθlens 206d stabilizes the scanning speed of the laser beams LB scanned by the polygon mirror 206c, on the photoconductive drum 205.

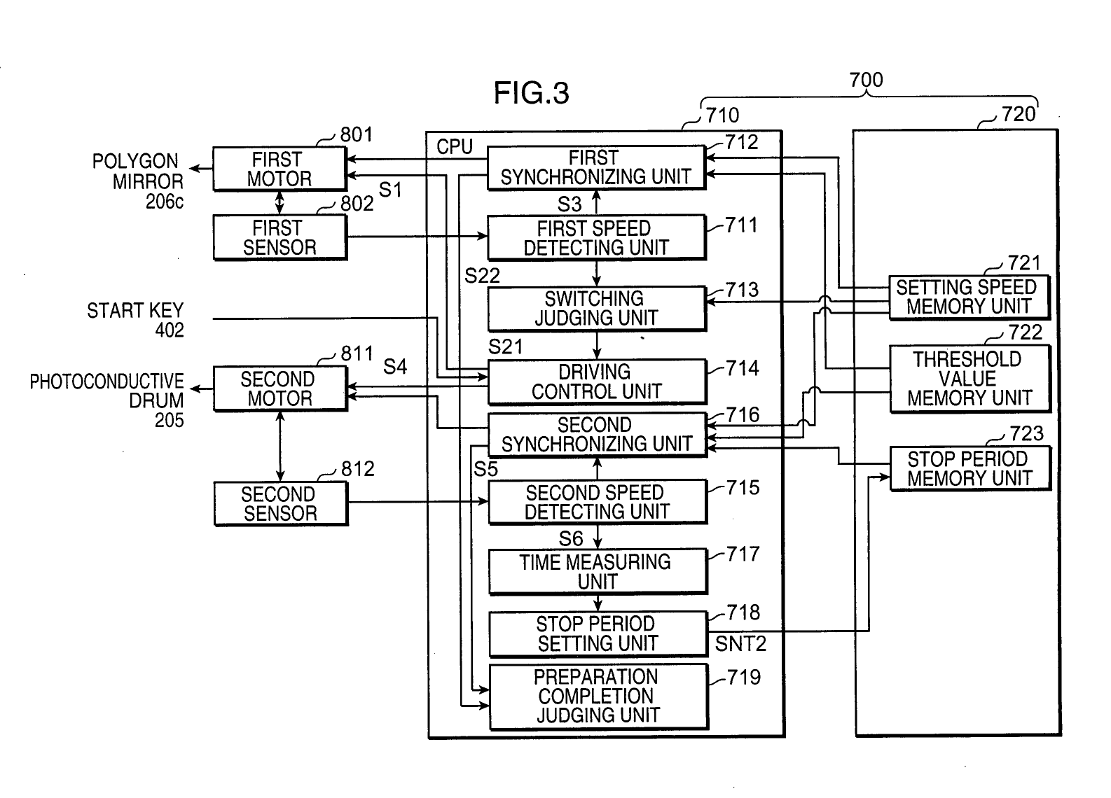

FIG. 3 is a block view showing an example of a functional configuration of a control unit in the copying machine 1 shown in FIG. 1. The copying machine 1 comprises a control unit 700 (corresponding to the driving control device) arranged in place in the copying machine 1 to control its operation. Here, the control unit 700 is composed of a CPU (Central Processing Unit) 700, a RAM (Random Access Memory) 720 to be used as a work area of the CPU, a ROM (Read Only Memory, not illustrated) for storing an image processing program or the like according to the invention, and the like.

Also, the copying machine 1 is equipped with a first motor 801 and a second motor 811 arranged in place in the copying machine, the first motor 801 (corresponding to the first driving unit) being adapted to drive the polygon mirror shown in FIG. 2, and the second motor 811 (corresponding to the second driving unit) being adapted to drive the photoconductive drum 205, the sheet-feed roller 202a˜202c and the fixing roller 208 serving as driving rollers without driving the polygon mirror. The first motor 801 and the second motor 811 are composed of a brushless DC motor or the like capable of controlling rotation speed.

A first sensor 802 (corresponding to a part of the first rotation speed detecting unit) and a second sensor 812 (corresponding to a part of the second rotation speed detecting unit) are respectively engaged with a driving shaft of the first motor 801 and the second motor 811, and are each composed of a PG (Pulse Generator), etc. for respectively detecting the rotation speed of the first motor 801 and second motor 811.

The CPU 710 comprises a first rotation speed detecting unit 711 (corresponding to a part of the first rotation speed detecting unit) for detecting a first rotation speed as a rotation speed of the polygon mirror 206; a first synchronizing unit 712 (corresponding to the first synchronizing unit) for controlling the first motor 801 so that an absolute value of the difference between the first rotation speed and a first reference rotation speed as a target value of the first rotation speed becomes equal to or lower than a first threshold value set in advance; a switching judging unit 713 (corresponding to the switching judging) for judging whether the first rotation speed has reached a value equal to or higher than the first switching speed; and a driving control unit 714 (corresponding to a driving control unit) for causing the second motor 811 to start driving of the photoconductive drum 205, in the case that the switching judging unit 713 judges that the first rotation speed reaches a value equal to or higher than the first switching speed.

The CPU 710 includes a second rotation speed detecting unit 715 (corresponding to a part of the first rotation speed detecting unit) for detecting a second rotation speed as a rotation speed of the photoconductive drum 205; a second synchronizing unit 716 (corresponding to the second synchronizing unit) for controlling the second motor 811 so that an absolute value of the difference between the second rotation speed and a second reference rotation speed as a target value of the second rotation speed becomes equal to or lower than a second threshold value set in advance; a time measuring unit 717 (corresponding to a part of the period setting unit) for measuring the period required for the second rotation speed to reach a second switching speed set in advance, after the second motor 811 starts driving of the photoconductive drum 205; a stop period setting unit 718 (corresponding to a part of the period setting unit) for setting a mirror stop period which coincides with the period measured by the time measuring unit 717; and a preparation completion judging unit 719 for judging whether the printing operations are completed.

The RAM 720 includes: a setting speed memory unit 721 for storing the first switching speed, the first reference rotation speed, the second switching speed, and the second reference rotation speed; a threshold value memory unit 722 for storing a first threshold value and a second threshold value; and a stop period memory unit 723 for storing a mirror stop period.

Here, the CPU reads and executes the driving control program according to the invention, which is stored beforehand in the ROM, etc. and thereby functions as a functional unit such as the first rotation speed detecting unit 711, first synchronizing unit 712, switching judging unit 713, and the like.

From the various types of data stored in the RAM 720 and ROM, data which may be stored on a detachable recording medium may be so configured as to make it readable by a drive unit, for instance, a hard disk drive, an optical disk drive, a flexible disk drive, a silicon disk drive, a cassette medium reader, or the like. In this case, the recording medium includes, for instance, a hard disk, an optical disk, a flexible disk, a CD, a DVD, a semiconductor memory or the like.

The first rotation speed detecting unit 711 determines the first rotation speed which is the rotation speed of the polygon mirror 206c by multiplying a predetermined proportionality coefficient with a rotation speed of the first motor 801 which is detected by the first sensor 802.

The first synchronizing unit 712 is adapted to control the first motor 801 so that an absolute value of the difference between the first rotation speed determined by the first rotation speed detecting unit 711 and the first reference rotation speed which is a target value of the first rotation speed stored in the setting speed memory 721 becomes equal to or lower than a first threshold value set in advance.

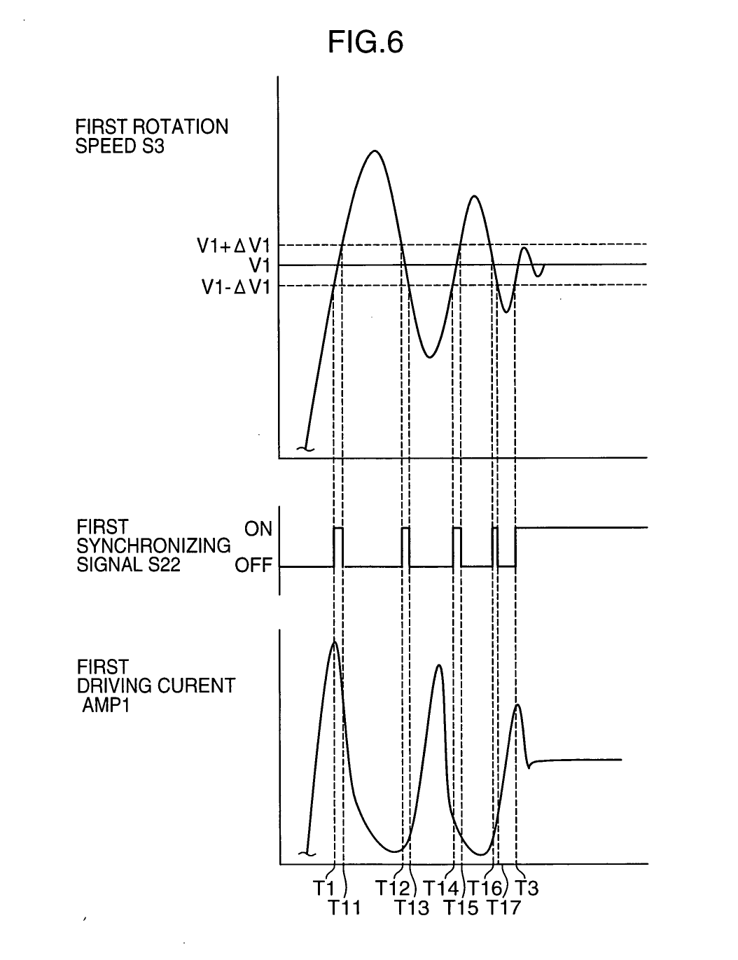

Here, in the case that the first rotation speed is less than a lower limit (lower limit=(first reference rotation speed V1)−(first threshold valueΔV1)), the first synchronizing unit 712 outputs an acceleration instruction signal to the first motor 801, whereas, in the case the first rotation speed exceeds an upper limit (upper limit=(first reference rotation speed V1)+(first threshold valueΔV1)), it outputs a deceleration instruction signal to the first motor 801 (FIG. 6).

The switching judging unit 713 judges whether the first rotation speed reaches a value equal to or higher than the first switching speed stored in the setting speed memory unit 721, after the first motor 801 starts driving of the polygon mirror. Here, for the sake of convenience, it is presumed that the first switching speed is set to the lower limit (lower limit=V1−ΔV1, as seen in FIG. 6) of the synchronization judging carried out by the first synchronizing unit 712. Since (first threshold value ΔV1)<<(first reference rotation speed V1), the first switching speed is substantially the same as the first reference rotation speed V1.

The driving control unit 714 starts driving of the first motor 801 in response to the pressing of the start key 402 (that is, receiving a print instruction signal). Also, in the case that it is determined by the switching judging unit 713 that the first rotation speed reaches a value equal to or higher than the first switching speed, the driving control unit 714 causes the second motor 811 to start driving of the photoconductive drum 205 and causes the first motor 801 to stop driving of the polygon mirror 206c for the mirror stop period which is stored in the stop period memory unit 723 and then causes the first motor 801 to re-start driving of the polygon mirror after the mirror stop period is over.

The second rotation speed detecting unit 715 determines the second rotation speed which is the rotation speed of the photoconductive drum 205 by multiplying a predetermined proportionality coefficient with a rotation speed of the second motor 811 which is detected by a second sensor 812.

The second synchronizing unit 716 is adapted to control the second motor 811 so that an absolute value of the difference between the second rotation speed determined by the second rotation speed detecting unit 715 and the second reference rotation speed which is a target value of the second rotation speed stored in the setting speed memory unit 721 becomes equal to or lower than a second threshold value set in advance.

Here, in the case that the second rotation speed is less than a lower limit (lower limit=(second reference rotation speed)−(second threshold value)), the second synchronizing unit 716 outputs an acceleration instruction signal to the second motor 811, whereas, in the case the second rotation speed exceeds an upper limit (upper limit=(second reference rotation speed)+(second threshold value)), it outputs a deceleration instruction signal to the second motor 811.

The time measuring unit 717 measures the period, using a timer, required for the second rotation speed to reach a second switching speed which is stored in the setting speed memory unit 721 (here, (second switching speed)=(second reference rotation speed)−(second threshold value)), after the second motor 811 starts driving of the photoconductive drum 205. However, since (second threshold value)<<(second reference rotation speed), the second switching speed is substantially the same as the second reference rotation speed.

The stop period setting unit 718 stores the period measured by the time measuring unit 717 as mirror stop period in the stop period memory unit 723 in advance.

The preparation completion judging unit 719 judges whether the printing preparation is completed. Specifically, it judges that the printing preparation is completed in the case that a state wherein the first rotation speed is synchronized with the first reference rotation speed and the second rotation speed is synchronized with the second reference rotation speed has continued for a predetermined period of time (for instance, 0.1 seconds).

The setting speed memory unit 721 stores a first switching speed, a first reference rotation speed, a second switching speed and a second reference rotation speed. The threshold value memory unit 722 stores a first threshold value and a second threshold value. The stop period memory unit 723 stores a mirror stop period set by the stop period setting unit 718.

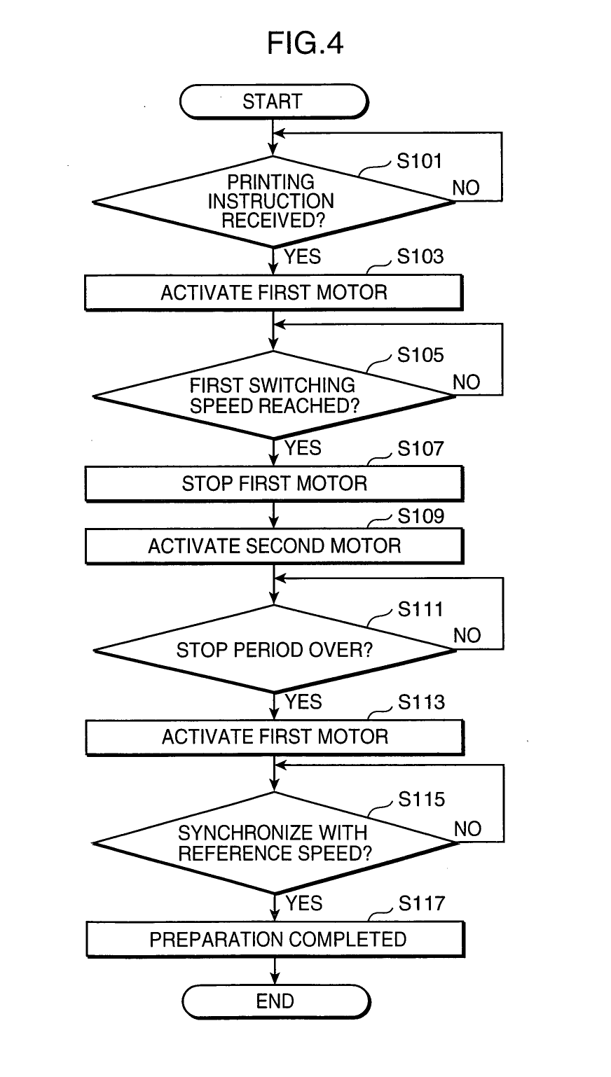

FIG. 4 is a flow chart showing one example of the operation of the control unit 700. The driving control unit 714 judges whether the start key 402 is pressed (in other words, whether a print-instructing signal is received) (Step S101). In the case it is judged that the start key 402 is not pressed (NO in Step S101), processing is suspended. In the case it is judged that the start key 402 is pressed (YES in Step S101), the first synchronizing unit 712 starts driving of the first motor 801 (Step S103).

Next, the switching judging unit 713 judges whether the first rotation speed is reached a value equal to or higher than the first switching speed (Step S105). In the case it is judged that the first rotation speed is not reached a value equal to or higher than the first switching speed (NO in Step S105), processing is suspended. In the case that it is judged that the first rotation speed is reached a value equal to or higher than the first switching speed (YES in Step S105), the driving control unit 714 causes the first motor 801 to stop driving of the polygon mirror 206c (Step S107), and causes the second motor 811 to start driving of the photoconductive drum 205 (Step S109).

Then, the driving control unit 714 judges whether the mirror stop period is over (Step S111). If it is judged that the mirror stop period is not over (NO in Step S111), processing is suspended. If it is judged that the mirror stop period is over (YES in Step S111), the driving control unit 714 causes the first motor 801 to restart driving of the polygon mirror 206c (Step S113).

The preparation completion judging unit 719 judges whether the first rotation speed is synchronized with the first reference rotation speed and the second rotation speed is synchronized with the second reference rotation speed (Step S115). In the case that it is judged that at least one of the first rotation speed and second rotation speed is not synchronized with the corresponding reference rotation speed (NO in Step S115), processing is suspended. If it is judged that the first rotation speed and the second rotation speed are synchronized with their corresponding reference rotation speeds for a period of 0.1 seconds or more (YES in Step S115), the preparation completion judging unit 719 judges that the preparation for printing is completed (Step S117) and a printing start instruction is outputted to the respective units of the copying machine 1, whereby the processing is finished.

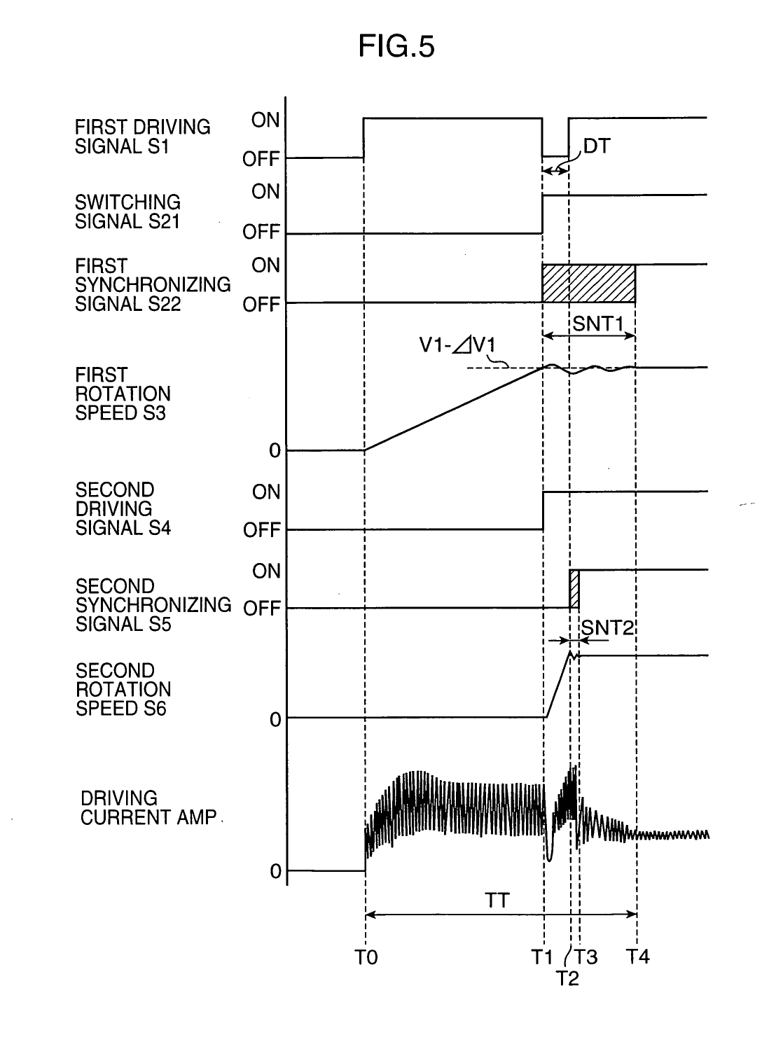

FIG. 5 is a timing chart showing an example of the operation of the control unit 700. FIG. 5 represents a graph illustrating changes that occur with the passage of time in the following items shown in the following order starting from the top of the chart: a first driving signal S1 outputted from the driving control unit 714 to the first motor 801; a switching signal S21 outputted from the switching judging unit 713 to the driving control unit 714 in the case that the first rotation speed reaches a value equal to or higher than the first switching speed; a first synchronizing signal S22 outputted from the first synchronizing unit 712 to the preparation completion judging unit 719 in the case that the first rotation speed is synchronized with a first reference rotation speed; a first rotation speed S3 detected by the first sensor 802; a second driving signal S4 outputted from the driving control unit 714 to the second motor 811; a second synchronizing signal S5 outputted from the second synchronizing unit 716 to the preparation completion judging unit 719 in the case that the second rotation speed is synchronized with the second reference rotation speed; a second rotation speed S6 of the second motor 811 detected by the second sensor 812; and a driving current AMP which is the sum between the driving current value of the first motor 801 and the driving current value of the second motor 811.

The start key 402 is pressed at time TO and the first driving signal S1 is turned ‘ON’. Next, the driving control unit 714 starts driving of the first motor 801, whereby the first rotation speed S3 is increased (accelerated), along with an increase in the value of the driving current AMP.

The first rotation speed S3 reaches a first switching speed (=V1−ΔV1, as shown in FIG. 6) at time T1 and the first synchronizing signal S22 is temporarily turned ‘ON’. The switching judging unit 713 turns the switching signal S21 ‘ON’ and the driving control unit 714 turns the first driving signal ‘OFF’, whereby the value of the driving current AMP is decreased. Also, the driving control unit 714 turns the second driving signal ‘ON’ to start driving of the second motor 811, whereby the second rotation speed S6 is increased (accelerated), along with an increase in the value of the driving current AMP.

Next, the driving signal unit 714 judges at time T2 that the mirror stop period DT is over, and the first driving signal S1 is turned ‘ON’, whereby the driving of the first motor 801 is restarted. At time T3, the second synchronizing signal S5 is in a continuously ‘ON’ state, and at time T4 the first synchronizing signal S22 is in a continuously ‘ON’ state, whereby the preparation completion judging unit 719 judges that the preparation for printing is completed.

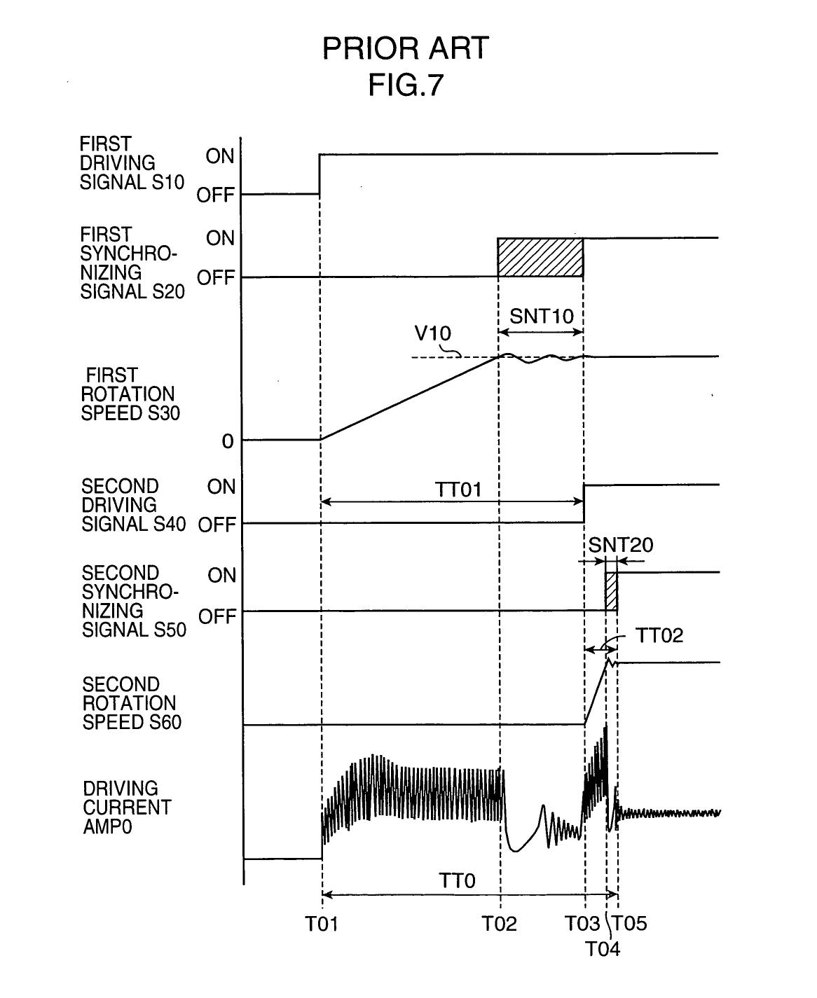

Here, the period from time T1 till time T4 is a first synchronizing period SNT1 when the first synchronizing signal S22 is turned ‘ON’ intermittently, while the period from time T2 till time T3 is a second synchronizing period SNT2 when the second synchronizing signal S5 is turned ‘ON’ intermittently. Also, the period from time TO till time T4 is the start-up period TT from pressing the start key until start-up is completed. It should be noted that the start-up period TT is shorter than the start-up period TT0 of the conventional image forming apparatus shown in FIG. 7, which can thus speed up the timing for the first printing. The maximum value of the driving current AMP is substantially equal to the maximum value of the driving current value AMP0 of the conventional image forming apparatus shown in FIG. 7, so that an increase in the power requirements is suppressed.

FIG. 6 is a timing chart showing an example of the changes occurring in the first rotation speed S3, the first synchronizing signal S22, and the driving current AMP1 of the first motor 801 during the first synchronizing period SNT1. The first synchronizing unit 712 outputs an accelerating instruction signal to the first motor 801 in the case that the first rotation speed S3 is less than a lower limit (lower limit=(first reference rotation speed V1)−(first threshold value ΔV1)), and a decelerating instruction signal to the first motor 801 in the case that the first rotation speed S3 exceeds an upper limit (upper limit=(first reference rotation s peed V1)+first threshold value ΔV1). For this reason, the first rotation speed S3 oscillates relative to the first reference rotation speed V1 as center, after a time T1 when the first synchronizing signal S22 is turned ‘ON’ for the first time.

In other words, during the period from time T11 till time T12 and the period from time T15 till time T16, the first rotation speed S3 exceeds the upper limit (upper limit=(first reference rotation speed V1)+(first threshold value ΔV1), and the decelerating instruction signal is outputted to the first motor 801. Also, during the period from time T13 till time T14, and the period from time T17 till time T3, the first rotation speed S3 is less than a lower limit (lower limit=(first reference rotation speed V1)−(first threshold value ΔV1)), and the accelerating instruction signal is output to the first motor 801. During the respective periods from time T1 till time T11, time T12 till time T13, time T14 till time T15, time T16 till time T15, and after time T3, the first synchronizing signal S22 is turned ‘ON’.

FIG. 7 is a timing chart showing an example of an operation of a conventional image forming apparatus. FIG. 7 represents a graph showing the changes occurring with the passage of time in the following items: a first driving signal S10, a first synchronizing signal S20, a first rotation speed S30, a second driving signal S40, a second synchronizing signal S50, a second rotation speed S60, and a driving current AMP0.

The start key is pressed at time T01 and the first driving signal S10 is turned ‘ON’. Next, the driving of the first motor is started thereby increasing (accelerating) the first rotation speed S30 and increasing the value of the driving current AMP0.

At time T02, the first synchronizing signal S20 is turned ‘ON’ intermittently thereby decreasing the value of the driving current value AMP0. Next, at time T03, the first synchronizing signal S20 is in a continuously ‘ON’ state and the second driving signal S40 is turned ‘ON’, whereby the driving of the second motor is started, which leads to an increase in the driving current AMP0. At time T04, the second synchronizing signal S50 is turned ‘ON’ intermittently, which causes a decrease in the driving current value AMP0. Then, at time T05, the second synchronizing signal S50 is continuously in a ‘ON’ state, whereby it is judged that the preparation for printing is completed.

Here, the period from time T02 till time T03 is a first synchronizing period SNT10 when the first synchronizing signal S20 is turned ‘ON’ intermittently, while the period from time T04 till time T05 is a second synchronizing period SNT20 when the second synchronizing signal S50 is turned ‘ON’ intermittently. Also, the period from time T01 till time T03 is a first start-up period TT01 from pressing the start key 402 and starting driving of the first motor until the start-up is completed. The period from time T03 till time T05 is a second start-up period TT02 from starting the second motor till the start-up is completed. The period from time T01 till time T05 is a start-up period TT0 from pressing the start key 402 till start-up is completed (TT0=first start-up period TT01+second start-up period TT02). It will be appreciated that the start-up period TT0 is longer than the start-up period TT according to the present embodiment, as shown in FIG. 5.

As described with reference to FIGS. 1-6, if it is judged that the first rotation speed S3 which is the rotation speed of the polygon mirror 206c is reached a value equal to or higher than the first switching speed (first switching rotation speed=V1−ΔV1, as shown in FIG. 6), the driving of the photoconductive drum 205 is started, while the driving of the polygon mirror 206c is stopped for a mirror stop period DT set in advance. Then, the driving of the polygon mirror 206c is re-started after the mirror stop period DT is over. Thereby, it is possible to speed up the timing for the first print, while suppressing power requirements.

Since the first switching speed (=V1−ΔV1) is set to be substantially the same as the first reference rotation speed V1, the driving of the polygon mirror 206c is stopped at a suitable timing at which the power required for driving the polygon mirror is equal to or lower than a predetermined value, which enables suppression of the power requirements when the driving of the polygon mirror 206c is restarted (at the time T2).

Since the first synchronizing unit 712 controls the first motor 801 such that an absolute value of the difference between the first rotation speed S3 and the first reference rotation speed V1 is equal to or lower than a first threshold value ΔV1 set in advance, the synchronization with the polygon mirror can be controlled with a desired accuracy by setting the first threshold value ΔV1 to a suitable value, while employing a simplified construction.

In addition, since the driving of the polygon mirror 206c is restarted at a suitable timing at which the power required for driving the photoconductive drum 205 is equal to or lower than a predetermined value, when the second switching speed is set to a suitable value, the power requirements can be suppressed.

Since the second switching speed is set so as to be substantially the same as the second reference rotation speed, the driving of the polygon mirror 206c can be restarted at a suitable timing at which the power required for driving the photoconductive drum 205 becomes equal to or lower than a predetermined value, thereby enabling suppression of the power requirements.

Further, since the second synchronizing unit 716 controls the second motor 811 such that an absolute value of the difference between the second rotation speed S6 and the second reference rotation speed becomes equal to or lower than a second threshold value set in advance, the synchronization with the photoconductive drum 205 can be controlled with a desired accuracy by setting the second threshold value to a suitable value, while employing a simplified construction.

The invention can take the following aspects.

Although a description has been given with respect to the present embodiment of a case that the image forming apparatus is a copying machine 1, other types of image forming apparatuses (for instance, a fax machine, a printer, or the like) may be employed.

For instance, in the case that the image forming apparatus is a printer connected to a personal computer in a manner enabling communication therewith, the timing at which the driving control unit 714 starts driving of the polygon mirror 206c may be the timing at which a print instruction information is received from the personal computer, in place of the timing at which the start key 402 is pressed.

Although a description has been given with respect to the present embodiment of a case that the first rotation speed detecting unit 711 uses the rotation speed of the driving shaft in the first motor 801 which is sensed by the first sensor 802 to detect a first rotation speed S3 which is a rotation speed of the polygon mirror 206c, it may also detect the first rotation speed S3 directly. In this case, sensors composed of PGs, etc. may be engaged with the rotary shaft of the polygon mirror 206c.

Similarly, although a description has been given of the case that the second rotation speed detecting unit 715 uses the rotation speed of the driving shaft of the second motor 811 which is sensed by the second sensor 812 to detect a second rotation speed S6 which is a rotation speed of the photoconductive drum 205, it may also detect the second rotation speed S6 directly.

Although a description has been given with respect to the present embodiment of a case that the first switching speed is set to a lower limit of the synchronization judging (lower limit=V1−ΔV1), it may be set to other values. For instance, the first switching speed may be set to the first reference rotation speed V1, or to the upper limit of the synchronizing judging (upper limit=V1+ΔV1).

Although a description has been given with respect to the present embodiment of a case that the first switching speed, the first reference rotation speed V1, the second switching speed and the second reference rotation speed are stored in advance in the setting speed memory unit 721, at least one of the first switching speed, the first reference rotation speed V1, the second switching speed and the second reference rotation speed may be set based on an input from the outside (for instance, input operation using the touch panel 401b). This improves convenience of the copying machine 1.

Although a description has been given with respect to the present embodiment of a case that the first threshold value ΔV1 and the second threshold value are stored in advance in the threshold value memory unit 722, at least one of the first threshold value ΔV1 and the second threshold value may be set based on an input from outside (for instance, input operation using the touch panel 401b). This improves convenience of the copying machine 1.

Although a description has been given with respect to the present embodiment of a case that the mirror stop period DT is stored in advance in the stop period memory unit 723, it may also be set based on an input from outside (for instance, input operation using the touch panel 401b), or it may be updated at a suitable time (for instance, each time the start key 402 has been pressed the 100^{th} time) by the stop period setting unit 718. In the former case, the convenience of the copying machine 1 is improved, whereas in the latter case, the mirror stop period DT is updated to a suitable value reflecting degradation of the respective units of the copying machine 1 caused by the passage of time.

Although a description has been given with respect to the present embodiment of a case that the mirror stop period DT is set to the time required for the second rotation speed S6 to reach a second switching speed (here, (second switching speed)=(second reference rotation speed)−(second threshold value):lower limit of the synchronization judging)) stored in the setting speed memory unit 721, after the second motor 811 starts driving of the photoconductive drum 205, it may also be set to other times. For instance, the second switching speed may be set to the upper limit of the synchronization judging (upper limit=(second reference rotation speed)+(second threshold value), and the mirror stop period DT may be set to a time required for the second rotation speed S6 to reach this second switching speed. Also, for example, the mirror stop period DT may be set to a value obtained by adding (or subtracting) a predetermined value (for example, 0.1 seconds) to the time required for the second rotation speed S6 to reach a second switching speed stored in the setting speed memory unit 721.

Although a description has been given with respect to the present embodiment of a case that the first copying machine 1 comprises the first motor 801 and the second motor 811, it may also comprise other driving sources (actuators) such as motors, in addition to the first motor 801 and the second motor 811.

Although a description has been given with respect to the present embodiment of a case that the preparation completion judging unit 719 judges that the preparation for printing is completed when a state wherein the first rotation speed is synchronized with the first reference rotation speed, and the second rotation speed is synchronized with the second reference rotation speed, continues for a predetermined period of time, it is sufficient that at least these two conditions be satisfied. For instance, the preparation completion judging unit 719 may judge that the preparation for printing is completed when the above two conditions and a condition that the temperature of the fixing roller 208 is equal to or higher than a predetermined temperature are all satisfied.

As described in the above, the driving control device according to one aspect of the invention is for use in an image forming apparatus having a first driving unit for driving a polygon mirror adapted to scan a laser beam to be irradiated on a photoconductive drum so that the polygon mirror is rotated at a first reference rotation speed set in advance and a second driving unit for driving the photoconductive drum so that the photoconductive drum is rotated at a second reference rotation speed set in advance, the driving control device comprises: a first rotation speed detecting unit for detecting a first rotation speed as a rotation speed of the polygon mirror; a switching judging unit for judging whether the first rotation speed reaches a value equal to or higher than a first switching speed set in advance, after the first driving unit starts driving of the polygon mirror; and a driving control unit for causing the second driving unit to start driving of the photoconductive drum, while causing the first driving unit to stop driving of the polygon mirror for a mirror stop period set in advance, in the case that the switching judging unit judges that the first rotation speed reaches a value equal to or higher than the first switching speed, and, after the mirror stop period is over, causes the first driving unit to restart driving of the polygon mirror.

The recording medium according to another aspect of the invention is a computer-readable recording medium in which a driving control program is recorded and is used in an image forming apparatus which has a computer; a first driving unit for driving a polygon mirror adapted to scan a laser beam to be irradiated on a photoconductive drum so that the polygon mirror is rotated at a first reference rotation speed set in advance; and a second driving unit for driving the photoconductive drum so that the photoconductive drum is rotated at a second reference rotation speed set in advance, wherein: the driving control program causes the computer to function as: a first rotation speed detecting unit for detecting a first rotation speed as a rotation speed of the polygon mirror; a switching judging unit for judging whether the first rotation speed reaches a value equal to or higher than a first switching speed set in advance, after the first driving unit starts driving of the polygon mirror; and a driving control unit for causing the second driving unit to start driving of the photoconductive drum, while causing the first driving unit to stop driving of the polygon mirror for a mirror stop period set in advance, in the case that the switching judging unit judges that the first rotation speed reaches a value equal to or higher than the first switching speed, and, after the mirror stop period is over, causes the first driving unit to restart driving of the polygon mirror.

According to the above-described structure, after the first driving unit starts driving of the polygon mirror, the first rotation speed detecting unit detects the first rotation speed as the rotating speed of the polygon mirror, and the switching judging unit judges whether the first rotation speed reached a value equal to or higher than the first switching speed set in advance. In the case that the switching judging unit judges that the first rotation speed reaches a value equal to or higher than the first switching speed, the driving control unit causes the second driving unit to start driving of the photoconductive drum, while causing the first driving unit to stop driving of the polygon mirror for a mirror stop period set in advance, and after the mirror stop period is over, causes the first driving unit to restart driving of the polygon mirror.

Accordingly, if it is judged that first rotation speed as the rotation speed of the polygon mirror reaches a value equal to or higher than the first switching speed set in advance, since the second driving unit starts driving of the photoconductive drum, while the first driving unit stops driving of the polygon mirror for a mirror stop period set in advance, and after the mirror stop period is over, the first driving unit restarts driving of the polygon mirror, it is possible speed up the timing for the first print while suppressing power requirements.

In other words, the driving of the polygon mirror is stopped for a mirror stop period starting from the moment when the first rotation speed as a rotation speed of the polygon mirror reaches a value equal to or higher than the first switching speed. Because of this, if the first switching speed and the mirror stop period are set to suitable values, it is possible to control driving of the first driving unit and second driving unit such that a period when the power required for driving the polygon mirror is equal to or higher than a predetermined value does not overlap with a period when the power required for driving the photoconductive drum is equal to or higher than a predetermined value. This enables suppression of the power requirements.

Also, since the driving of the photoconductive drum is started in the case it is judged that the first rotation speed as a rotation speed of the polygon mirror reaches a value equal to or higher than the first switching speed, the polygon mirror and the photoconductive drum are started up in parallel. Because of this, it is possible to speed up the timing of the first print.

Accordingly, if it is judged that first rotation speed as the rotation speed of the polygon mirror reaches a value equal to or higher than the first switching speed set in advance, since the second driving unit starts driving of the photoconductive drum, while the first driving unit stops driving of the polygon mirror for a mirror stop period set in advance, and after the mirror stop period is over, the first driving unit restarts driving of the polygon mirror, it is possible to speed up the timing for the first print while suppressing power requirements.

The first switching speed is preferably set to a value substantially the same as the first reference rotation speed.

In this case, since the first switching speed is set to a value substantially the same as the first reference rotation speed, the driving of the polygon mirror can be stopped at a suitable timing at which the power required for driving the polygon mirror is equal to or higher than a predetermined value, which enables to suppress power requirements at the time the driving of the polygon mirror is restarted.

Preferably, the above driving control device further comprises a first synchronizing for controlling the first driving unit such that an absolute value of a difference between the first rotation speed and the first reference rotation speed becomes equal to or lower than a first threshold value set in advance.

In this case, because the first synchronizing unit controls the first driving unit such that an absolute value of a difference between the first rotation speed and the first reference rotation speed becomes equal to or lower than a first threshold value set in advance, synchronization can be controlled with a desired accuracy, while employing a simplified structure, by setting the first threshold value to a suitable value.

Preferably, the first switching speed is set to a value obtained by subtracting the first threshold value from the first reference rotation speed.

In this case, the timing when the photoconductive drum is activated can be speeded up, which makes it possible to speed up the timing of the first print.

Preferably, the above driving control device further comprises a second rotation speed detecting unit for detecting a second rotation speed as a rotation speed of the photoconductive drum, and a period setting unit for measuring the period required for the second rotation speed to reach the second switching speed set in advance, after the second driving unit stares the photoconductive drum, and setting the mirror stop period so as to be coincident with the measured period.

In this case, the second rotation detecting unit detects a second rotation speed as rotation speed of the photoconductive drum. Then, the period setting unit measures the period required for the second rotation speed to reach the second switching speed set in advance, after the second driving unit starts driving of the photoconductive drum and sets the mirror stop period so as to be coincident with the measured period.

Accordingly, since the driving of the polygon mirror is re-started at a suitable timing at which the power required for driving the photoconductive drum becomes equal to or lower than a predetermined value, when the second switching speed is set to a suitable value, it is possible to suppress the power requirements.

Preferably, the second switching speed is set to a value which is substantially the same as the second reference rotation speed.

In this case, since the second switching speed is set to a value which is substantially the same as the second reference rotation speed, the driving of the polygon mirror is re-started at a suitable timing at which the power required for driving the photoconductive drum becomes equal to or lower than a predetermined value, which enables suppression of the power requirements.

Preferably, the above driving control device further comprises a second synchronizing unit for controlling the second driving unit such that an absolute value of a difference between the second rotation speed and the second reference rotation speed becomes equal to or lower than a second threshold value set in advance.

In this case, since the second synchronizing unit controls the second driving unit such that an absolute value of a difference between the second rotation speed and the second reference rotation speed becomes equal to or lower than a second threshold value set in advance, synchronization can be controlled with a desired accuracy, while employing a simplified structure, by setting the second threshold value to a suitable value.

Preferably, the second switching speed is set to a value obtained by subtracting the second threshold value from the second reference rotation value.

In this case, the timing when the driving of the polygon mirror is restarted can be speeded up, which makes it possible to speed up the timing of the first print.

The image forming apparatus according to another aspect of the present invention comprises a first driving unit for driving a polygon mirror adapted to scan a laser beam to be irradiated on a photoconductive drum so as to rotate the polygon mirror at a first reference rotation speed set in advance; a second driving unit for driving the photoconductive drum so as to rotate at a second reference rotation speed set in advance; and the driving control device as described above.

According to the above configuration, the first driving unit drives the polygon mirror adapted to scan a laser beam to be irradiated on a photoconductive drum so that the polygon mirror is rotated at a first reference rotation speed set in advance, while the second driving unit drives the photoconductive drum so that the photoconductive drum is rotated at a second reference rotation speed set in advance. Further, the driving control device as described above controls driving of the first driving unit and second driving unit. Accordingly, an image forming apparatus is achieved which is capable of speeding up the timing for the first print while suppressing the power requirements.

This application is based on Japanese patent application No. 2005-103578 filed in Japan Patent Office on Mar. 31, 2005, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A driving control device for use in an image forming apparatus having a first driving unit for driving a polygon mirror adapted to scan a laser beam to be irradiated on a photoconductive drum so that the polygon mirror is rotated at a first reference rotation speed set in advance and a second driving unit for driving the photoconductive drum so that the photoconductive drum is rotated at a second reference rotation speed set in advance, comprising:
a first rotation speed detecting unit for detecting a first rotation speed as a rotation speed of the polygon mirror;
a switching judging unit for judging whether the first rotation speed reaches a value equal to or higher than a first switching speed set in advance, after the first driving unit starts driving of the polygon mirror; and
a driving control unit for causing the second driving unit to start driving of the photoconductive drum, while causing the first driving unit to stop driving of the polygon mirror for a mirror stop period set in advance, in the case that the switching judging unit judges that the first rotation speed reaches a value equal to or higher than the first switching speed, and, after the mirror stop period is over, causes the first driving unit to restart driving of the polygon mirror.

2. The driving control device according to claim 1, wherein:
the first switching speed is set to a value which is substantially the same as the first reference rotation speed.

3. The driving control device according to claim 1, further comprising:
a first synchronizing unit for controlling the first driving unit such that an absolute value of a difference between the first rotation speed and the first reference rotation speed becomes equal to or lower than a first threshold value set in advance.

4. The driving control device according to claim 3, wherein:
the first switching speed is set to a value obtained by subtracting the first threshold value from the first reference rotation speed.

5. The driving control device according to claim 1, further comprising:
a second rotation speed detecting unit for detecting a second rotation speed as a rotation speed of the photoconductive drum; and
a period setting unit for measuring the period required for the second rotation speed to reach the second switching speed set in advance, after the second driving unit stares the photoconductive drum, and setting the mirror stop period so as to be coincident with the measured period.

6. The driving control device according to claim 5, wherein:
the second switching speed is set to a value which is substantially the same as the second reference rotation speed.

7. The driving control device according to claim 5, further comprising:
a second synchronizing unit for controlling the second driving unit such that an absolute value of a difference between the second rotation speed and the second reference rotation speed becomes equal to or lower than a second threshold value set in advance.

8. The driving control device according to claim 7, wherein:
the second switching speed is set to a value obtained by subtracting the second threshold value from the second reference rotation value.

9. An image forming apparatus comprising:
a first driving unit for driving a polygon mirror adapted to scan a laser beam to be irradiated on a photoconductive drum so that the polygon mirror is rotated at a first reference rotation speed set in advance;
a second driving unit for driving the photoconductive drum so that the photoconductive drum is rotated at a second reference rotation speed set in advance; and
a driving control device according to claim 1.

10. A computer-readable recording medium in which a driving control program is recorded and is used in an image forming apparatus which has a computer; a first driving unit for driving a polygon mirror adapted to scan a laser beam to be irradiated on a photoconductive drum so that the polygon mirror is rotated at a first reference rotation speed set in advance; and a second driving unit for driving the photoconductive drum so that the photoconductive drum is rotated at a second reference rotation speed set in advance, wherein:
the driving control program causes the computer to function as:
a first rotation speed detecting unit for detecting a first rotation speed as a rotation speed of the polygon mirror;
a switching judging unit for judging whether the first rotation speed reaches a value equal to or higher than a first switching speed set in advance, after the first driving unit starts driving of the polygon mirror; and
a driving control unit for causing the second driving unit to start driving of the photoconductive drum, while causing the first driving unit to stop driving of the polygon mirror for a mirror stop period set in advance, in the case that the switching judging unit judges that the first rotation speed reaches a value equal to or higher than the first switching speed, and, after the mirror stop period is over, causes the first driving unit to restart driving of the polygon mirror.
